(19) United States
(12) Patent Application Publication
(10) Pub. No.: US 2026/0285454 A1
(43) Pub. Date: Sep. 24, 2026

(54) DUAL BREATHABLE GAS SUPPLY APPARATUS

(71) Applicant: Daniel Reynolds, Willingham (GB)

(72) Inventor: Daniel Reynolds, Willingham (GB)

(21) Appl. No.: 19/086,853

(22) Filed: Mar. 21, 2025

(51) Int. Cl. B63C 11/16; A62B 18/04; A62B 18/10; B63C 11/14

(52) U.S. Cl. CPC B63C 11/16; A62B 18/04; A62B 18/10; B63C 11/14

(57) ABSTRACT

Disclosed is a breathable gas supply apparatus, for connecting with a diving face mask or helmet. The gas supply apparatus is connectable with an inlet and outlet of a rebreather or reclaim unit for a first supply of breathable gas for closed-circuit use, and connectable with a second supply of breathable gas for open-circuit use. The breathable gas supply apparatus comprises: a first valve for sealing or opening supply from the rebreather or reclaim unit; and for opening or sealing supply from the second supply of breathable gas; and a third valve capable of exhausting exhaled gas during open-circuit use and retaining exhaled gas during closed-circuit use. The breathable gas supply apparatus is configured such that sealing the first valve corresponds to enabling supply of compressed gas and exhaust corresponds to enabling switching between two sources of breathable gas without interruption.

### TECHNICAL FIELD

The present invention relates to underwater breathing systems used in diving equipment. More specifically, it pertains to a breathable gas supply apparatus for divers that is connectable to either a closed-circuit rebreather (gas reclamation unit) or a secondary open-circuit gas source. The apparatus incorporates integrated valve mechanisms enabling a seamless switch between the closed-circuit and open-circuit gas supplies without interrupting the delivery of breathing gas to the user.

### BACKGROUND

A full-face mask or helmet is usually supplied with breathable gas from a compressed gas cylinder or other external supply (i.e. from the surface or a habitat) through a demand valve/regulator. No bite mouthpiece is required. This is typically termed open-circuit. Rebreather technology uses a closed-circuit principle, and the two technologies are both different and not readily combined in a full-face mask or helmet.

For instance, replacement of an open-circuit regulator with a rebreather results in flow restrictions and bi-directional flow in various parts of the apparatus, leading to restriction of breathing and build-up of carbon dioxide. Rebreathers rely on wide passages as one's breathing is the only driving force, whereas open-circuit systems use compressed gas and, thus, the standard masks are provided with narrow flow passages unsuitable for rebreather use. Typically, a rebreather used with a full-face mask still requires a bite mouthpiece, to prevent flooding the rebreather in the case of water ingress, and to prevent mixing of fresh and exhaled gas in the mask cavity, worsening the above problems.

Although the two technologies are known and one might theoretically think of combining them, it is reiterated that the technologies are different and not readily combined, unless various problems are addressed and solved through inventive insight. For example, if one did combine the technologies this brings with it the serious disadvantage of excessive protrusion of the apparatus from the head, generating torque, which resists head movement and, potentially, displaces the seal in the case of a full-face mask. Further, this increases “dead space” in which fresh and exhaled gas may mix, and this risk of leakage, means that the rebreather still requires a bite mouthpiece, and this removes the normal advantage of using a full face mask which allows easy communication as one can readily talk, and unrestricted breathing as one can fully open the mouth.

It is well known that a bite mouthpiece obstructs speech and also provides breathing resistance.

Therefore, in light of the foregoing discussion, there exists a need to overcome the aforementioned drawbacks. The present invention is aimed at solving these and other problems associated with the prior art, or simple combinations thereof.

### SUMMARY

The present invention provides a breathable gas supply apparatus. Preferably, the invention provides an interface between a diving rebreather or other breathing gas reclamation unit, an open-circuit gas supply, and a helmet or full-face mask. The aim of the present disclosure is to provide an uninterrupted transition between closed-circuit and open-circuit gas supplies to ensure the continuous delivery of breathable gas. The aim of the present disclosure is achieved by a gas supply apparatus comprising valve means for selectively sealing and opening gas supply from a rebreather or reclaim unit and an open-circuit source, which operates in a mechanically coordinated manner to alternate between the two gas sources without interruption, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is a schematic drawing of a breathable gas supply apparatus, upon which the embodiment of FIGS. 2, 3, 4a and 4b, and 5a and 5b are based;

FIG. 2 is a front elevation of a face mask including the breathable gas supply apparatus;

FIG. 3 is a side elevation of the face mask of FIG. 2;

FIGS. 4A and 4B are side elevations of the switch blocks of FIGS. 2 and 3; and

FIGS. 5A and 5B are cross-sectional views of switch blocks, being parts of the face mask of FIGS. 2 to 4;

### DETAILED DESCRIPTION OF THE INVENTION

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a breathable gas supply apparatus, for connecting with a diving face mask or helmet, the breathable gas supply apparatus is connectable with an inlet of a rebreather or reclaim unit for a first supply of breathable gas for closed-circuit use, and connectable with a second supply of breathable gas for open-circuit use, wherein the breathable gas supply apparatus comprises valve means for:
sealing or opening supply from said rebreather or reclaim unit; and
opening or sealing supply from said second supply of breathable gas;
   wherein, the breathable gas supply apparatus is configured such that sealing supply from said rebreather or reclaim unit corresponds to opening supply from said second supply of breathable gas, and vice-versa, enabling switching between two sources of breathable gas without interruption in supply.

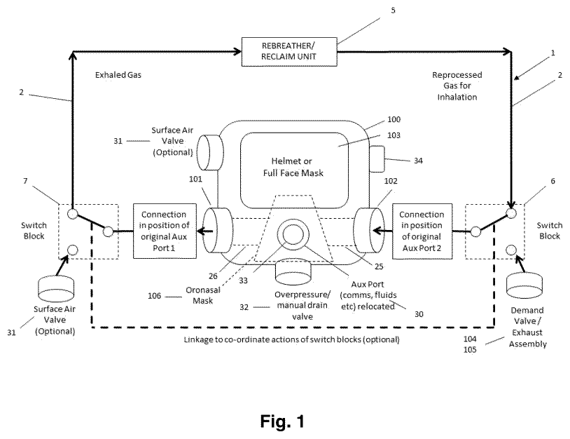

Referring to FIG. 1, illustrated is a schematic drawing of a breathable gas supply apparatus, in accordance with an embodiment of the present disclosure.

The invention will be described in relation to a known face mask (or helmet) 100 which includes auxiliary connection ports 101 and 102 located at side regions of the face mask, a transparent view screen 103, a demand valve 104, an exhaust valve 105 and an internal oronasal mask 106. The face mask 100 includes one or more seals 107 for sealing to a user's head.

The auxiliary connection ports 101 and 102 are normally used for a microphone or external breathing port (not shown at those locations) but, for the present invention, are repurposed for use as closed-circuit breathing connections. The demand valve 104 typically provides breathable gas from a pressurized gas supply. This supply is retained in the present invention and is used only when the closed-circuit is deactivated or sealed off, for instance on the surface, in the case of a malfunction, or during donning or doffing of the breathable gas supply apparatus when the closed-circuit element of the system must be sealed to prevent water ingress, or when unlimited supplies of open-circuit gas are available, for instance when using surface or habitat-supplied gas, where open-circuit gas is used by default and the closed-circuit system is used for emergency purposes. The exhaust valve 105 is normally used for the ejection of exhaled gas, and an additional overpressure (or manual) exhaust valve 32 is preferably placed at the base of the face mask so as to also eject any liquid or water that may have entered the face mask. The transparent view screen 103 enables the user to see their surroundings underwater, and the breathable gas supply apparatus is sealed to the user's head or neck with a seal 107.

The internal oronasal mask 106 is used to reduce the build-up and re-inhalation of carbon dioxide within the face mask (or helmet), and to prevent water vapour from the user's breath condensing on the transparent view screen 103, and within the face mask as a whole. In the present invention the oronasal mask is modified as explained below.

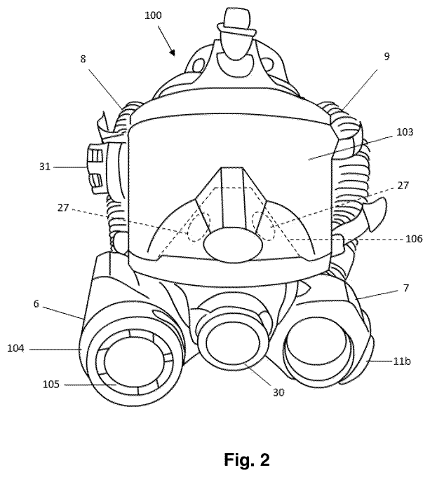

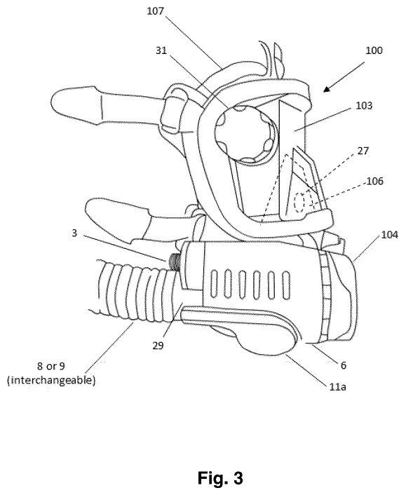

For convenience, FIG. 1 through to 5, i.e., FIGS. 1, 2, 3, 4a, 4b, 5a and 5b, will all be described together. FIGS. 1 to 5 show a breathable gas supply apparatus, generally identified by reference 1. The gas supply apparatus 1 includes a rebreather apparatus 2, for closed-circuit use, and a supply of compressed gas 3, for open-circuit use. The rebreather apparatus 2 and supply of compressed gas 3 are independently usable to enable breathing of a user of the breathable gas supply apparatus 1, such that a supply of breathable gas is always available, and the user may switch between the rebreather apparatus 2 and supply of compressed gas 3.

The supply of compressed gas 3 is supplied with breathable gas from cylinders or tanks or other external source (not shown) which are standard and known in the art, which

cylinders/tanks or external source per se do not form part of the invention. Advantageously, Compressed gas may be supplied directly into the face mask 100 in the region(s) of the transparent view screen 103 to help minimise fogging.

The rebreather apparatus 2 includes a rebreather/reclaim unit 5 which is capable of receiving exhaust gas from breathing and reprocessing the exhaust gas to provide breathable gas for inhalation by the user. The rebreather/reclaim unit 5 reprocesses the breathing gas by removing carbon dioxide and restoring oxygen content. The rebreather apparatus 2 further includes switch blocks 6; 7 (including rebreather valves), which are connected to auxiliary ports 101/102 of the face mask 100, and have hoses 8; 9 for transferring exhaled gas to the rebreather/reclaim unit 5 and reprocessed breathable gas back to the face mask 100. The rebreather/reclaim unit 5 is standard and known in the art.

Each switch block 6; 7 includes internal valves 10a; 10b (first valve means) and external handles 11a; 11b, respectively, operatively connected to the internal valves 10a; 10b. Each handle 11a; 11b is operable by rotation from a first condition in which the valve 10a; 10b is open to a second condition in which the valve 10a; 10b is closed, so as to open and close passageways for transmission of exhaust gas/breathable gas to/from the rebreather/reclaim unit 5. In this example, the handles 11a; 11b are rotatable through 180 degrees between first and second conditions—although this is not essential. Each switch block 6; 7 is a manually operated, airtight switching mechanism that enables switching between breathing from the rebreather/reclaim unit 5 and an optional surface air intake 31 or supply of compressed gas 3.

With respect to operation of the switch blocks 6; 7 to open and close passageways leading to the rebreather/reclaim unit 5, both operate in a similar way. However, in this example switch block 6 has additional functions—although it could be either switch block.

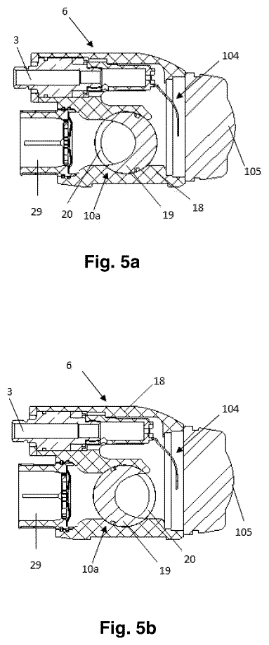

Each switch block 6; 7 includes a one-way valve 29 at its distal end from the face mask 100, which serves to ensure the correct direction of flow of gas around the rebreather/reclaim unit 5, but is also so located to prevent flooding of the rebreather/reclaim unit 5. As shown in FIGS. 5a and 5b, the one-way valve 29 is located between the switch block 6 and the corresponding hose 8—and switch block 7 and hose 9 are arranged the same way. The one-way valve 29 may be integrated as part of the switch blocks 6; 7, or indeed as part of the hoses 8; 9 but are preferably separate components. By being separate, and easily interchanged or turned around, direction of flow around the closed-circuit can be switched, or one can easily substitute different versions having different connections for use with a variety of different rebreather/reclaim units. These one-way valves 29 are preferentially positioned in a location that will minimize bidirectional flow of gas (and, so, prevent re-inhalation of carbon dioxide), yet also prevent the inadvertent intake of water into the rebreather/reclaim unit 5. The one-way valves 29 are preferably check valves.

As shown in more detail in FIGS. 5a and 5b, the internal valve 10a includes 5, a valve housing 18, movable valve member 19 and various seals (not shown)/sealing surfaces between the two. The valve member 19 is, essentially, cylindrical and hollow, and includes a valve aperture 20 formed in a cylindrical side wall of the valve member 19, the position of which can be rotated through rotating handle 11a so as to open and close passageways for gas through the valve 10a. The valve member 19 and valve housing 18 may be sealed by sealing means such as O-rings, or simply by a tight fit, and may optionally contain means to lubricate its surfaces to keep out salt water or other debris. Internal valve 10b (within switch block 7) operates in this context in the same manner as internal valve 10a.

As shown in more detail in FIGS. 5a and 5b, switch block 6 is operatively connected to the supply of compressed gas 3. Movable valve member 19 directs the aperture 20 either towards the rebreather unit 2 or towards the demand-valve mechanism 104 and exhaust 105 of the supply of open circuit gas 3.

Switch block 6 also comprises the exhaust 105 (third valve means), which has essentially the same function as a normal exhaust 105 in open-circuit use, but which, in closed-circuit use, is disconnected from the breathing system along with open circuit gas supply 3.

Thus, Switch Block 6 has selectable inlets from both the open circuit gas supply 3 and closed circuit gas supply from the rebreather 2, a fluid connection to the face mask (or helmet) 100, and a selectable outlet to the exhaust valve 105. The mechanism is configured so that by the manually activated rotation of movable valve member 19, and the consequent movement of aperture 20, demand valve 104 and exhaust valve 105 are simultaneously connected with the helmet or face mask 100 as the closed circuit gas supply is disconnected, and simultaneously disconnected as the closed circuit gas supply is connected.

Advantageously, this configuration offers reduced mechanical and procedural complexity over other solutions wherein each the valve means 19, gas supply 3 and exhaust valve 105 are physically separate items and must either be mechanically linked by additional mechanisms or must be activated or deactivated individually by the user in the correct sequence. Advantageously, this configuration enables the gas supply 3 to operate without a dedicated shutoff mechanism of its own, thus reducing mechanical complexity and maintenance requirement, removing the problems associated with sliding sealing mechanisms exposed to substantial differential pressure, and reducing the resistance to gas flow, reducing resistance to the user's breathing.

Advantageously, this configuration enables the demand valve 104 to be pressurized at all times during operation. Thus, the user may quickly verify if the valve is functional by manually triggering the demand mechanism. Any gas let into the cavity within demand valve 104 due to increasing ambient pressure during descent will be vented during ascent through exhaust valve 105. Simultaneously, this addition of gas prevents any damage to exhaust valve 105 during descent.

The breathable gas supply apparatus 1 further includes a modified oronasal mask. The oronasal mask 106 includes an inlet and an outlet 25; 26 direct from/to the switch blocks 6; 7, which are used for closed-circuit breathing. One-way valves located in a nasal bridge region of the oronasal mask 106 have the dual function of allowing compressed gas from the transparent view screen 103 into the oronasal mask 106, and preventing exhaust gas from exiting the oronasal mask 106 at this point. This prevents fogging and also ensures that, in open-circuit use, exhaled gas passes correctly through the exhaust valve 105 and, in closed-circuit use, exhaled gas is recirculated for reprocessing in the rebreather/reclaim unit 5. In open-circuit use, dry breathable gas preferably first passes across the transparent view screen 103, causing any condensation to evaporate, before entering the oronasal mask 106 to be inhaled.

The face mask or helmet 100 further includes relocated auxiliary ports 30 which may be used for communications and/or drinking/feeding functions. In addition, or alternatively, one switch block includes a surface air intake 31—which is preferably designed to close underwater. The port 30 if used for communications allows cables for a microphone to pass inside the face mask 100, and further may include a push-to-talk button 33 and earpiece 34 allowing the diver to both talk and listen to communications via a through water communications unit. The same earpieces 34 may be optionally used to relay electronically generated messages relevant to the dive, for instance information on depth, time, gas mixture, heading, reserves of essential supplies, and system status. The invention provides the advantage that speech and verbal messages are uninterrupted by the loud noises associated with open-circuit SCUBA diving, namely the emission of compressed gas through the demand valve, and the escape of bubbles through the exhaust. Thus, far clearer communications are possible. Further, the port 30 is configured such that any additional communications and/or drinking/feeding functions are unhindered by operation of the one or more valves.

The relocation of the auxiliary port to be directly proximal to the user's mouth further improves the simplicity and functionality of any microphone and/or feeding and drinking installation.

The breathable gas supply apparatus of the invention may include flexible or rigid hoses, or a combination thereof. In the case of the invention being a full-face mask 100, hoses 8; 9 are preferably flexible to allow movement of the head. Conversely, in the case of the invention being a helmet 100, hoses 8; 9 may be flexible or more rigid as the user may rotate their head within the helmet 100.

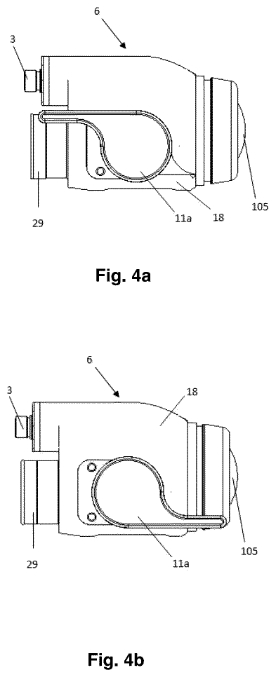

The position of the external handles 11a; 11b may indicate a direction to which the corresponding valve is operative. For example, and as shown in FIGS. 4a, 4b, 5a, and 5b, the elongate part of the handle 11a points towards the rebreather hose 8, indicating closed-circuit use. Whereas, if the handle 11a is rotated 180 degrees to its second condition, the elongate part of the handle 11a points towards the demand valve 14/optional surface air valve 31, indicating open-circuit use.

In an alternative, switch blocks 6; 7 may be mounted directly to a face mask or helmet if auxiliary ports are unavailable or such connection is less preferred.

In use, switching between closed-circuit use and open-circuit use is easily achieved. Owing to the integration between switch block 6 and the supply of compressed gas 3—through aperture 20—and between switch block 6 and the exhaust 105 by simply turning handle 11a through 180 degrees a first rebreather valve (valve 10a for the inlet or outlet of the rebreather) is closed and, simultaneously, the connections to the source of compressed gas 3 and exhaust 105 are opened. Further, by simply turning handle 11b through 180 degrees a second rebreather valve (valve 10b for the other of the outlet or inlet of the rebreather) is closed. In these conditions of the valves, the user breathes compressed breathable gas from cylinders or external supply (not shown). As each of the handles 11a; 11b is conveniently located at a side region of the face mask/helmet 100, each can be easily operated at the same time with the user's hands.

Moreover, switching between open-circuit use and closed circuit use simply involves rotating the handles 11a; 11b in an opposite manner. This has the effect of opening both rebreather valves (valves 10a; 10b) which opens hoses 8; 9 to the rebreather unit 5, closes the gas path to the demand regulator 104 supplying compressed gas 3, and closes the gas path to the exhaust 105. In these conditions of the valves, the user breathes reprocessed air from the rebreather unit 5.

It should be noted that the above is the preferred mode of operation, but the operation of the breathable gas supply apparatus may be simply adapted to provide additional functionality.

For example, whilst it is essential that when the rebreather is closed another supply of breathable gas is opened, that need not be compressed gas as it could be provided by a surface air valve. In addition, it is not essential that opening the rebreather necessarily closes the gas path to the supply of compressed gas, as it may be preferred to top-up the rebreather and use both sources of breathable gas at the same time for a period of time. Those skilled in the art will understand that the direction of movement of gas through the breathable gas supply apparatus 1 may be reversed without significant change to the breathable gas supply apparatus 1. Those skilled in the art will also understand that operation of the switch blocks 6; 7 may be reversed, such that switch block 7 is operatively connected to one or more of the supply of compressed gas and/or the exhaust. Further, the breathable gas supply apparatus may be easily modified to combine the functions of switch blocks 6 and 7 into a single operation, should this be desired.

1. A breathable gas supply apparatus, for connecting with a diving face mask or helmet, the breathable gas supply apparatus is connectable with an inlet of a rebreather or reclaim unit for a first supply of breathable gas for closed-circuit use, and connectable with a second supply of breathable gas for open-circuit use, wherein the breathable gas supply apparatus comprises valve means for:
sealing or opening supply from said rebreather or reclaim unit; and
opening or sealing supply from said second supply of breathable gas;
wherein, the breathable gas supply apparatus is configured such that sealing supply from said rebreather or reclaim unit corresponds to opening supply from said second supply of breathable gas, and vice-versa, enabling switching between two sources of breathable gas without interruption in supply.

2. The breathable gas supply apparatus as claimed in claim 1, wherein the valve means is configured to be movable between:
a first condition in which said diving face mask or helmet is provided in fluid communication with a first supply of breathable gas for closed-circuit use; and
a second condition in which said diving face mask or helmet is provided in fluid communication with a second supply of breathable gas for open-circuit use.

3. The breathable gas supply apparatus as claimed in claim 1, wherein a first switch block comprises the valve means, a demand valve and an exhaust valve.

4. The breathable gas supply apparatus as claimed in claim 3, wherein the first switch block comprises a rebreather or reclaim unit supply passageway, which is interruptible by the valve means.

5. The breathable gas supply apparatus as claimed in claim 3, wherein the first switch block comprises a second supply passageway, which is interruptible by the valve means.

6. The breathable gas supply apparatus as claimed in claim 5, wherein the second supply passageway comprises the demand valve and the exhaust valve.
